(19) United States
(12) Patent Application Publication
(10) Pub. No.: US 2023/0089143 A1
(43) Pub. Date: Mar. 23, 2023

(54) METHOD FOR GAME LIVE BROADCAST INTERACTION AND TERMINAL

(71) Applicant: BEIJING DAJIA INTERNET INFORMATION TECHNOLOGY CO.,LTD., Beijing (CN)

(72) Inventor: Wenjing Zheng, Beijing (CN)

(21) Appl. No.: 17/712,759

(22) Filed: Apr. 4, 2022

(30) Foreign Application Priority Data
Sep. 23, 2021 (CN) 202111117663.8

(51) Int. Cl. A63F 13/537; G06F 3/0484; H04N 21/2187; A63F 13/35

(52) U.S. Cl. CPC A63F 13/537; G06F 3/0484; H04N 21/2187; A63F 13/35

(57) ABSTRACT

A method for game live broadcast interaction includes: in response to detecting that a target account has entered a preset game live broadcast room, obtaining an interaction mode selected by the target account; and displaying an interface corresponding to the interaction mode selected by the target account on the terminal. The interaction mode includes a shared perspective mode or an independent perspective mode. The shared perspective mode is configured to provide a live broadcast interface from the perspective of an anchor in the preset game live broadcast room, and the independent perspective mode is configured to provide a game interface from the perspective of the target account participating in the preset game live broadcast room.

### CROSS REFERENCE TO RELATED APPLICATIONS

This application is based on and claim priority to Chinese Patent Application No. 202111117663.8, filed on Sep. 23, 2021, the content of which is incorporated herein by reference in its entirety.

### TECHNICAL FIELD

The present disclosure relates to a technical field of data processing, and in particular to a method and an apparatus for game live broadcast interaction, an electronic device and a storage medium.

### BACKGROUND

With the rapid development of the live broadcast industry, the game live broadcast industry has developed rapidly. At present, there are many game live broadcast platforms that provide users with online game live broadcast services.

### SUMMARY

According to a first aspect of the present disclosure, there is provided a method for game live broadcast interaction, which is applied to a terminal. The method includes: in response to detecting that a target account has entered a preset game live broadcast room, obtaining an interaction mode selected by the target account, in which the interaction mode includes a shared perspective mode or an independent perspective mode, the shared perspective mode is configured to provide a live broadcast interface from the perspective of an anchor in the preset game live broadcast room, and the independent perspective mode is configured to provide a game interface from the perspective of the target account; and displaying an interface corresponding to the selected interaction mode on the terminal.

According to a second aspect of the present disclosure, there is provided a terminal including a processor and a memory for storing instructions executable by the processor. The processor is configured to execute the method for game live broadcast interaction as described in the above first aspect.

It should be understood that the above general description and the following detailed description are only explanatory, without any limitations to the disclosure.

### BRIEF DESCRIPTION OF THE DRAWINGS

The drawings herein are incorporated into the specification and constitute a part of the specification, show embodiments in accordance with the disclosure, and are used to explain the principle of the disclosure together with the specification, which do not constitute an improper limitation to the disclosure.

FIG. 1 is a schematic diagram of a scenario according to an embodiment.

FIG. 2 is a flowchart of a method for game live broadcast interaction according to an embodiment.

FIG. 3 is a flowchart of the step S210 in FIG. 2.

FIG. 4 is a schematic diagram of an application scenario according to an embodiment.

FIG. 5 is a schematic diagram of another application scenario according to an embodiment.

FIG. 6 is a schematic diagram of yet another application scenario according to an embodiment.

FIG. 7 is a schematic diagram of yet another application scenario according to an embodiment.

FIG. 8 is a schematic diagram of yet another application scenario according to an embodiment.

FIG. 9 is a schematic diagram of yet another application scenario according to an embodiment.

FIG. 10 is a block diagram of an apparatus for game live broadcast interaction according to an embodiment.

FIG. 11 is a block diagram of an electronic device according to an embodiment.

### DETAILED DESCRIPTION

Exemplary embodiments will be described in detail herein, examples of which are illustrated in the accompanying drawings. Where the following description refers to the drawings, the same numerals in different drawings refer to the same or similar elements unless otherwise indicated. The implementations described in the embodiments below do not represent all implementations consistent with the disclosure. Rather, they are merely examples of apparatuses and methods consistent with some aspects of the disclosure as detailed in the appended claims.

In the related art, when the users view the game live broadcast through the game live broadcast platform, they can generally perform interactions by sending bullet screens on the live broadcast interface, sending gifts to the anchor, etc., which makes the participation degree of users not strong and easily leads to the user loss. In order to solve the above problems, embodiments of the present disclosure provide a method and an apparatus for game live broadcast interaction, an electronic device and a storage medium.

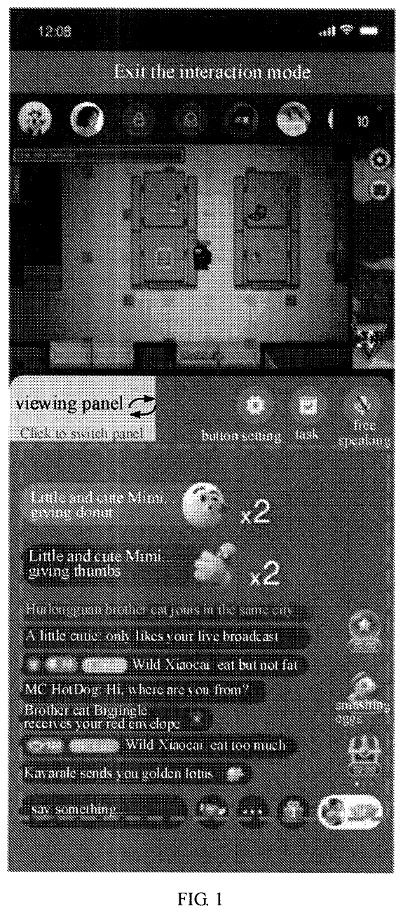

In the embodiment according to the present disclosure, as shown in FIG. 1, which is a schematic diagram of a scenario according to an embodiment of the present disclosure. Referring to FIG. 1, when the target account enters a game live broadcast room of the game live broadcast platform, a “viewing panel” control may be displayed on an interface of the game live broadcast room. The control is a switchable control, and when the user clicks the control, the game live broadcast room may switch from the viewing interface to an interaction interface. That is, the control may be changed from the “viewing panel” to the “interaction panel”.

When the target account enters the game live broadcast room, the initial default can be a live game viewing interface corresponding to the “viewing panel”. In the interface, a live game picture of the anchor is pushed onto a terminal where the target account is located. In the disclosure, the target account may refer to a terminal user or an account owner. As illustrated in FIG. 1, the upper part of the interface in FIG. 1 is a live game picture, the middle left of the interface is a “viewing panel” control and display content in a dashed box at the lower part of the interface can be comments, bullet screens and the like sent by the users and the given gifts, etc. It can also be set according to actual needs. When the target account enters the game live broadcast room, the initial default can also be set to the “interaction panel”, which is not limited in the embodiments.

When a click operation of the “viewing panel” control is received from the target account, the space may be switched from the “viewing panel” to the “interaction panel”. At this time, the lower part of the interface may correspondingly switch to display such as a control corresponding to the interaction panel. On the interface of the interaction panel, the target account may further select an interaction mode. The interaction mode may be a shared perspective mode or an independent perspective mode. The shared perspective mode is configured to provide a live broadcast interface of the anchor in the preset game live broadcast room, and the independent perspective mode is configured to provide a game interface from the perspective of the target account participating in the preset game live broadcast room. The detailed description may be referred as follows.

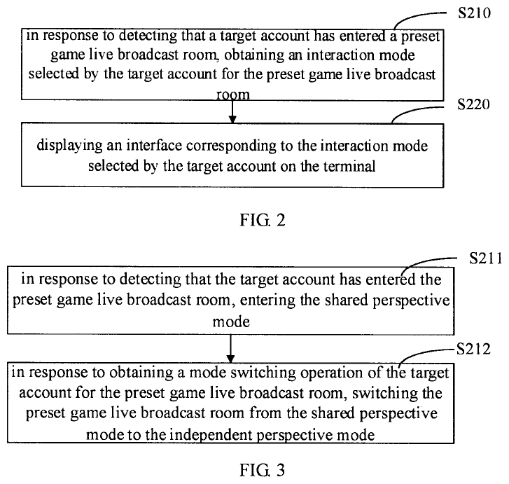

FIG. 2 is a flow chart of a method for game live broadcast interaction according to an embodiment. As shown in FIG. 2, the method is applied to a terminal, and the method may include the following steps at S210-S220

At S210, in response to detecting that a target account has entered a preset game live broadcast room, an interaction mode selected by the target account for the preset game live broadcast room is obtained.

The interaction mode includes a shared perspective mode or an independent perspective mode. The shared perspective mode is configured to provide a live broadcast interface from the perspective of an anchor in the preset game live broadcast room, and the independent perspective mode is configured to provide a game interface from the perspective of the target account participating in the preset game live broadcast room.

At S220, an interface corresponding to the interaction mode selected by the target account is displayed on the terminal.

In the embodiment according to the present disclosure, in response to detecting that the target account has entered the preset game live broadcast room, e.g., when the target account has entered the interaction mode corresponding to the “interaction panel” in FIG. 1, the target account may also be asked to select a specific mode corresponding to the interaction mode, such as the shared perspective mode or the independent perspective mode. The shared perspective mode is to provide the target account with a screen when the anchor in the preset game live broadcast room broadcasts a game, that is, the perspective of the anchor playing the game. The bullet screens and comments sent by other users, gifts given by other users and the like may be also viewed while the game live broadcast screen of the anchor is viewed. The target account may also reward the anchor, send comments and bullet screens, etc., may also apply for a voice connection request in a voice connection sequence area. After permission is obtained, the users may communicate with the anchor or other users through voice.

The independent perspective mode is to provide the users with a channel for playing games with the anchor. When the target account selects the independent perspective mode, a game entry interface is pushed to the target account. The target account may also join in the game of the anchor to play together with the anchor or with other users, which are not limited by the embodiments of the present disclosure. When the target account plays a game with the anchor, the pushed video screen is the game interface and the live broadcast interface of the anchor may be closed.

In the game live interaction method according to the embodiments of the present disclosure, in response to detecting that the target account has entered the preset game live broadcast room, the interaction mode selected by the target account for the preset game live broadcast room is obtained, and the interface corresponding to the interaction mode selected by the target account is displayed on the terminal. In this way, the users can actively participate in the game live broadcast room and can interact with the anchor in a way such as playing games with the anchor, thus increasing the user stickiness of the platform and avoiding insufficient participation degree in the related art in performing interactions by ways of sending bullet screens or giving gifts to the anchor, etc., which easily leads to the user loss.

Based on the above embodiment, in another embodiment according to the present disclosure, before the step at S210, the method may further include the following step at S201.

At S201, in response to detecting that the target account has entered the preset game live broadcast room, the target selection mode of the target account for the preset game room is obtained, in which the target selection mode includes an interaction mode or a viewing mode; and in response to receiving the target selection mode of the target account being the interaction mode, the step S210 is executed.

Referring to FIG. 1, when the target account enters a game live broadcast room of the game live broadcast platform, the interface of the game live broadcast room displays the “viewing panel” control, and the game live broadcast room is in the viewing mode. In an embodiment, the control is a function switchable control. In response to receiving a trigger from the user to click on the control, the game live broadcast room may switch from the viewing interface to the interaction interface, that is, the game live broadcast room may enter the interaction mode. In this way, the users can choose a viewing mode or an interaction mode according to their needs, so that the users can have more choices, thus increasing the attractiveness of the game live broadcast platform to users and avoiding the user loss.

Based on the foregoing embodiment, as shown in FIG. 3, in another embodiment according to the present disclosure, the step S210 may further include the following steps at S211-S212.

At S211, in response to detecting that the target account has entered the preset game live broadcast room, the shared perspective mode is entered.

At S212, in response to obtaining a mode switching operation of the target account for the preset game live broadcast room, the preset game live broadcast room is switched from the shared perspective mode to the independent perspective mode.

In the embodiment according to the present disclosure, in response to detecting that the target account has entered the preset game live broadcast room, the default is to first enter the shared perspective mode. Since many users on the live video platform like to watch playing games by the anchor, they can first enter the shared perspective mode to watch the game picture from the perspective of the anchor. After interests of the users have been mobilized, the users can click the function switch control on the interface according to their own needs, so as enter the independent perspective mode and participate in the anchor's game. This avoids a situation where many users are overwhelmed by directly entering the independent perspective mode and the tediousness caused by related operations needed to enter the shared perspective mode. This is not limited by the embodiments of the present disclosure and can also be specifically set as needed.

Based on the above embodiment, in another embodiment according to the present disclosure, when the interaction mode is the independent perspective mode, the method may further include the following steps at S230-S240.

At S230, a game interface of the preset game live room is displayed on the terminal. One or more game controls are set on the game interface.

At S240, in response to receiving a trigger operation on the one or more game controls, operation data corresponding to the trigger operation is sent to a \ server.

In the embodiment according to the present disclosure, the game interface includes a game picture area and an operation panel. The game picture area is configured to display a game picture, and the operation panel is provided with the plurality of game controls. Different games are provided with corresponding game controls on the operation panel.

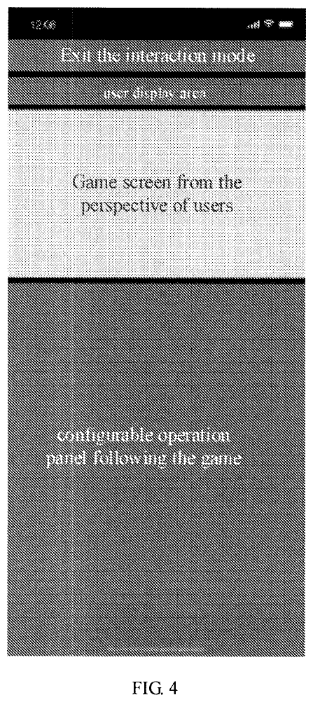

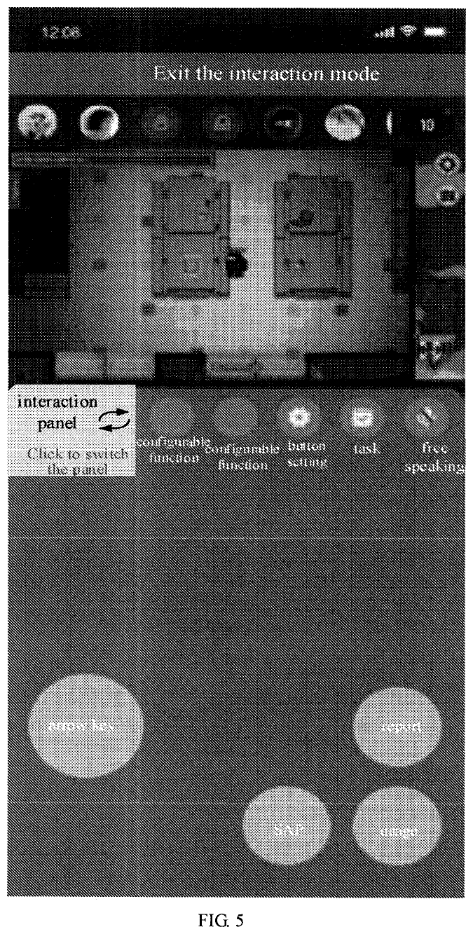

Specifically, as shown in FIG. 4, the game interface can be divided into four areas. The two areas in the lower part of the interface are “game picture from the perspective of users (i.e., the game picture area)” and “configurable operation panel following the game (i.e., the operation panel area)”. In a schematic diagram of a scenario according to the present disclosure, referring to FIG. 5, the user can control the game through the game controls on the operation panel, and the game picture from the perspective of users is displayed in the game picture area.

Based on the foregoing embodiment, in another embodiment according to the present disclosure, the method may further include the following steps at S250-S260.

At S250, in response to detecting that the anchor in the preset game live broadcast room is in a game waiting state, a game request for joining the anchor sent by the target account is received.

At S260, in response to successfully joining the game of the anchor, the target account is provided with a game picture from the perspective of the target account.

In the embodiments according to the present disclosure, generally, it is a game that can be played by more than one person. Generally, the anchor is in a waiting state (where he waits for other game players to join) after a game ends and before the next game starts. At this time, if the user wants to play a game with the anchor, he can send a request to the anchor and will join the anchor's game after obtaining the anchor's permission. After the game starts, the game picture from the perspective of users may be pushed to the terminal of users. Here, the user may be the target account.

Based on the foregoing embodiment, in another embodiment according to the present disclosure, the method may further include the following steps at S270-S280.

At S270, in response to detecting that the target account has entered the preset live game room, the function of the panel switching control is set as an interaction panel. The interaction panel is configured to provide the game interface for the target account.

At S280, in response to receiving a trigger operation of the target account on the panel switching control, the function of the panel control is switched from the interaction panel to a viewing panel.

The viewing panel is configured to provide the target account with a live game video screen corresponding to the target account, and the live video game picture is displayed with a bullet screen and/or a reward.

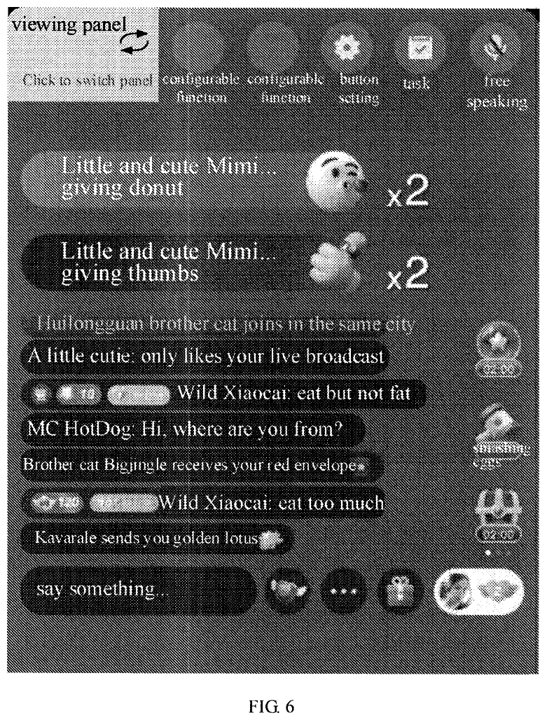

In the embodiment according to the present disclosure, the target account can achieve switching by clicking on a panel switching space, i.e., switching interfaces between the interaction panel and the viewing panel. On the interface where the interaction panel is located, the target account can interact with the anchor by participating in the anchor's game, and can also view the comments and bullet screens posted by users, rewards and the like on the viewing panel. In an example, the interface as shown in FIG. 6 (that is, the interface where the viewing panel is located) may be entered after the user performs the interface switching operation from the interface where the interaction panel is located as shown in FIG. 5.

Based on the foregoing embodiment, in another embodiment according to the present disclosure, the method may further include the following steps at S291-S292.

At S291, in response to the interaction mode being a shared perspective mode, a live game picture of the anchor is displayed in a first preset area of the live broadcast interface, and user comments are displayed in a second preset area of the live broadcast interface.

At S292, in response to receiving comment information input by the target account, the comment information input by the target account is displayed in the second preset area of the live broadcast interface.

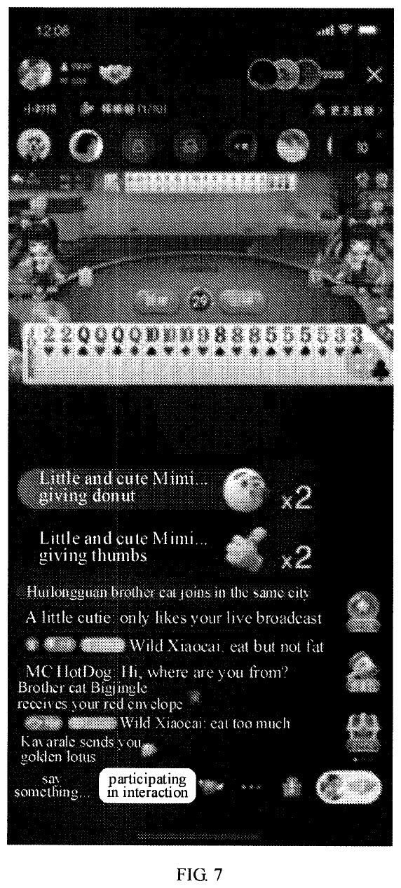

In the embodiment according to the present disclosure, referring to FIG. 7 which is a schematic diagram of a scenario in the shared perspective mode in the embodiment. When the interaction mode is the shared perspective mode, the live game picture of the anchor is displayed in the first preset area of the live broadcast interface and the user comments are displayed in the second preset area of the live broadcast interface. The first preset area is the upper area of the interface, and the second preset area is the lower area in the figure, which are respectively used to display the live broadcast screen and the comment information of users.

Based on the foregoing embodiment, in another embodiment according to the present disclosure, the method may further include the following steps at S293-S294.

At S293, in response to receiving a voice connection request of the target account, the target account is added to a connection list. The connection list includes voice connection requests with different priorities set based on voice connection time.

At S294, in response to detecting that the voice connection request of the target account is of the highest priority, a voice connection prompt is sent to the target account.

In the embodiments according to the present disclosure, it may be determined according to a number of players or the game mode, that is, the same game may correspond to different numbers of microphone positions. When binding with the game is completed, the game side needs to transmit a default number of microphone positions and when the in-game mode changes, the game side needs to re-transmit the number of microphone positions. By default, an avatar of the anchor can be displayed in the first position in a voice connection sequence area and the arrangement of remaining positions may be changed according to a connection sequence of users or a voice connection sequence. When the number of microphone positions exceeds one interface, the number of microphone positions may be displayed on the right side. In addition, the voice connection sequence area supports swiping left and right to view microphone loaded users. When the user speaks, his avatar can be displayed with a breathing effect. When the microphone position is free, clicking on the microphone position corresponds to initiating a voice connection application. When the microphone position is locked, there may be a prompt of “the microphone position has been locked by the anchor and cannot be applied”. In addition, different operation panel contents can be provided for microphone loaded users and non-microphone loaded users.

The above game interface contains basic components that all gameplays include, UI controls are distributed over the above panel, and a number of controls can be increased as the gameplay needs with functions following.

In the embodiment according to the present disclosure, the related interface may also include the following function settings.

Voice connection and disconnection, when the user has not applied for the voice connection, the button may display “Apply for the voice connection” and the connection may be initiated in response to clicking; when the user is in the connection list, the button may display “Applying” and a toast prompt that “Already in the voice connection list, please wait for the anchor to agree” may be displayed in response to clicking; when the user loads onto the microphone, the button displays “Exit the voice connection sequence” and a pop-up window prompts that “Are you sure to exit the voice connection sequence?” in response to clicking; the user downloads the microphone after confirming.

Speaking, when the user has not enabled a microphone permission, the user may be prompted to enable the microphone permission when the user loads onto the microphone; when the user has enabled the microphone permission, the microphone may be automatically turned on after the user loads onto the microphone, and the icon may be displayed in a volume change of the speech. The microphone may be turned off after clicking and may be turned on after clicking again. When the user does not load onto the microphone, the button is set to a non-clickable state and when clicked, a toast prompt that “Please load onto the microphone first” may be displayed. When the anchor makes the microphone loaded user download, the button is set to a non-clickable state and when clicked, a toast prompt that “The anchor has downloaded your microphone, please contact the anchor to reopen it” may be displayed.

Task, the task is issued by the server and the task content can be a task of live broadcast room type (such as how long to participate in the gameplay, etc.) or an in-game type (such as participating in 3 rounds of cards in the game, etc.). The task content is not fixed and can be configured with product needs and game needs. After the task is completed, the task state changes and the user receives a reward.

Game interaction components, they are located below the basic components, and their specific style and number change with the game.

Panel switching, multiple gameplays are supported in the same game configuration, and the panel can be changed by clicking this button. The operation panel can be configured with panel switching for multiple gameplays, and the interaction components change with the panel changes. On the one hand, the richness of interaction gameplay is increased, and on the other hand, operations at different levels of interaction can be configured from the perspective of product functions to meet the user needs at different levels. Taking “Fight the Landlord” as an example, an “interaction panel” and an “onlooker panel” are configured.

Interaction panel, both the microphone loaded users and non-microphone loaded users can participate in the operation, in which the microphone loaded users operate as a “brain trust”, the selected set of poker cards may be displayed to the anchor synchronously on the game side, and the non-microphone loaded users may perform single cards guessing.

Onlooker panel, both the microphone loaded users and non-microphone loaded users can participate in the operation, in which a user may spend free virtual currency of the platform in the game for sending props to the opponents who are facing the anchor, so as to enhance the atmosphere, and the effect of the props can be viewed by all members.

In the embodiments of the disclosure, the toast prompt may refer to a kind of lightweight feedback, which may often appears in the form of a small pop-up window at any position of the screen and automatically disappear after 1 to 2 seconds.

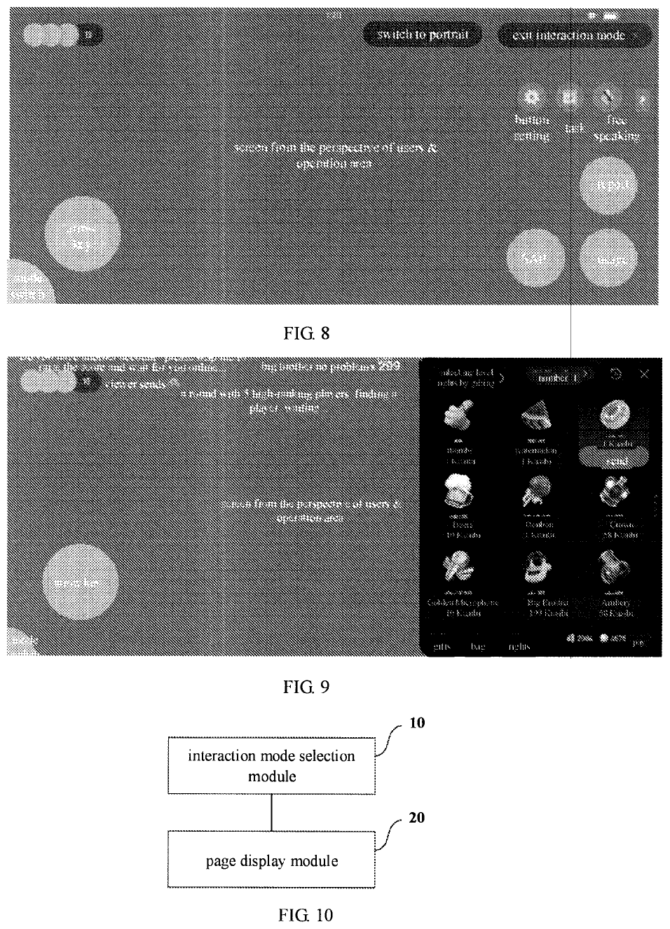

In other embodiments according to the present disclosure, in the independent perspective mode, it can also be displayed in landscape, as shown in FIG. 8, in the embodiment, there are two ways to enter the landscape mode for the independent perspective mode. By default, operations at the landscape mode can be supported by a portrait screen. A “switch to landscape” button is clicked in the game picture area to switch to the landscape mode. Alternatively, the game supports a landscape operation and entering the interaction mode of independent perspective directly enters the landscape state. In the embodiment, the landscape interaction mode may display a “switch to portrait” button when the game supports the portrait screen mode, and may not display the “switch to portrait” button when the game does not support the portrait screen mode.

In the embodiment, the logic of displaying the voice connection sequence area or not is the same as that in the portrait screen mode. When there is a functional need of the voice connection sequence area, 3 user avatars together with the number of voice connection sequence may be abbreviated and when there is no need, it may not be displayed. In response to clicking an avatar in the voice connection sequence area, a voice connection list may be displayed. In an embodiment, the voice connection sequence list may be displayed in a pop-up panel on the right in response to the clicking action. By default, the top of the list is the anchor, and the remaining positions are arranged according to the connection sequence of users and the voice connection sequence. When all microphone positions cannot be displayed on one screen, they can be displayed in a way of swiping up and down.

In addition, the user clicks a mode switch button to switch between different control configurations in the landscape mode. There are two basic panel configurations in the landscape state of the user independent perspective mode, i.e., an interaction panel for mapping game operations and a viewing panel. The interaction panel is displayed by default. More panel states may be added based on gameplay needs.

Combined with FIG. 9, a component configuration state for the viewing panel is entered from the default displayed interaction panel by clicking the “panel switch” button, and a simplified version of a viewing experience function area is added at a fixed position above the basic components in the middle of the right side. The functions such as “sending bullet screens”, “giving gifts” and “setting bullet screens” are equipped at the area, and more functions may be configured here. Clicking the “sending bullet screens” may call up a keyboard to enter and send the content. Clicking the “giving gifts” may call up a gift panel and gifts are given when the user has enough free virtual currency. The gifts may be displayed to all users. When the user does not have enough free virtual currency, the text in a pop-up window prompts that the balance is insufficient and whether to recharge. When the recharge is performed, the interaction mode may exit, and when the user executes the recharge process, the normal viewing mode may keep after the recharge is successful. Clicking the “setting bullet screens” may close the top display of bullet screens, clicking it again may open the top display and clicking it may close the top display again.

FIG. 10 is a block diagram of apparatus for game live broadcast interaction according to an embodiment. Referring to FIG. 10, the apparatus is applied to a terminal, and includes an interaction mode selection module 10 and an interface display module 20.

The interaction mode selection module is configured to in response to detecting that a target account has entered a preset game live broadcast room, obtain an interaction mode selected by the target account for the preset game live broadcast room. The interaction mode includes a shared perspective mode or an independent perspective mode. The shared perspective mode is configured to provide a live broadcast interface from the perspective of an anchor in the preset game live broadcast room, and the independent perspective mode is configured to provide a game interface from the perspective of the target account participating in the preset game live broadcast room. The interface display module is configured to display an interface corresponding to the interaction mode selected by the target account on the terminal.

In an embodiment according to the present disclosure, the apparatus further includes: a selection mode determining module and an interaction mode selecting module. The selection mode determination module is configured to in response to detecting that the target account has entered the preset game live broadcast room, obtain a target selection mode of the target account for the preset game live broadcast room. The target selection mode includes an interaction mode or a viewing mode. The interaction mode selection module is further configured to in response to receiving that the target selection mode of the target account is the interaction mode, obtain the interaction mode selected by the target account for the preset game live broadcast room.

In an embodiment according to the present disclosure, the selection mode determination module includes a shared mode entering unit and a mode switching unit. The shared mode entering unit is configured to enter the shared perspective mode in response to detecting that the target account has entered the preset game live broadcast room. The mode switching unit is configured to switch the preset game live broadcast room from the shared perspective mode to the independent perspective mode in response to obtaining a mode switching operation of the target account for the preset game live broadcast room.

In an embodiment according to the present disclosure, in response to the interaction mode being an independent perspective mode, the apparatus further includes a game interface display module and a trigger operation receiving module. The game interface displaying module is configured to display a game interface of a game in the preset game live room for the target account on the terminal, in which a plurality of game controls is set on the game interface. The trigger operation receiving module is configured to receive a trigger operation of the target account on the plurality of game controls, and send operation data corresponding to the trigger operation to a preset server.

In an embodiment according to the present disclosure, the game interface includes a game picture area and an operation panel. The game picture area is configured to display a game picture, and the operation panel is provided with the plurality of game controls; in which different games are provided with corresponding game controls on the operation panel.

In an embodiment according to the present disclosure, the apparatus further includes a game request receiving module and a game picture sending module. The game request receiving module is configured to receive a game request to join the anchor sent by the target account in response to detecting that the anchor in the preset game live broadcast room is in a game waiting state. The game picture sending module is configured to provide the target account with a game picture from the perspective of the target account in response to successfully joining the game of the anchor.

In an embodiment according to the present disclosure, the game interface is also provided with a panel switching control. The apparatus further includes: a first function switching module and a second function switching module. The first function switching module is configured to set the function of the panel switching control as an interaction panel in response to detecting that the target account has entered the preset live game room, in which the interaction panel is configured to provide the game interface for the target account. The second function switching module is configured to in response to receiving a trigger operation of the target account on the panel switching control, switch the function of the panel control from the interaction panel to a viewing panel, in which the viewing panel is configured to provide the target account with a live game video screen corresponding to the target account, and the live game video screen is displayed with a bullet screen and/or a reward.

In an embodiment according to the present disclosure, the apparatus further includes: a display module and comment information displaying module. The display module is configured to in response to the interaction mode being a shared perspective mode, display a live game picture of the anchor in a first preset area of the live broadcast interface, and display user comments in a second preset area of the live broadcast interface. The comment information display module is configured to in response to receiving comment information input by the target account, display the comment information input by the target account in the second preset area of the live broadcast interface.

In an embodiment according to the present disclosure, the apparatus further includes: an connection processing module and a prompt module. The game request receiving module is configured to in response to detecting that the anchor in the preset game live broadcast room is in a game waiting state, receive a game request to join the anchor sent by the target account. The game picture sending module is configured to in response to successfully joining the game of the anchor, provide the target account with a game picture from the perspective of the target account.

Regarding the apparatus in the above-mentioned embodiment, the specific manner in which each module performs operations has been described in detail in the embodiment of the method, which will not be described in detail here.

The apparatus for game live broadcast interaction according to the embodiment of the present disclosure, in response to detecting that the target account has entered the preset game live broadcast room, the interaction mode selected by the target account for the preset game live broadcast room is obtained and the interface corresponding to the interaction mode selected by the target account is thus displayed on the terminal. In this way, users can actively participate in the game live broadcast room, and can interact with the anchor by playing games with the anchor, thus increasing the user stickiness of the platform and avoiding insufficient participation degree in the related art in performing interactions by ways of sending bullet screens or giving gifts to the anchor, etc., which easily leads to the user loss.

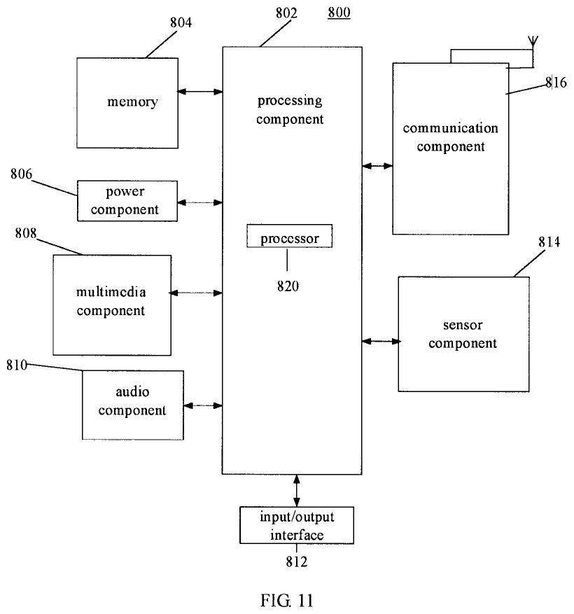

FIG. 11 is a block diagram illustrating a device 800 for game live broadcast interaction in the embodiment of the disclosure. For example, the device 800 is an electronic device, which may be specifically a mobile phone, a computer, a digital broadcasting terminal, a messaging device, a game console, a tablet device, a medical device, a fitness equipment, a personal digital assistant, etc.

As illustrated in FIG. 11, the device 800 may include one or more components: a processing component 802, a memory 804, a power supply component 806, a multimedia component 808, an audio component 810, an input/output (I/O) interface 812, a sensor component 814, and a communication component 816.

The processing component 802 typically controls overall operations of the device 800, such as operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate interaction between the processing component 802 and other components. For example, the processing component 802 may include a multimedia module for convenience of interaction between the multimedia component 808 and the processing component 802.

The memory 804 is configured to store various types of data to support operations of the device 800. Examples of such data include instructions for any applications or methods operated on the device 800, contact data, phonebook data, messages, pictures, video, etc. The memory 804 may be implemented by any type of volatile or non-volatile memory devices, or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 806 provides power for various components of the device 800. The power supply component 806 may include power supply management system, one or more power supplies, and other units related to generating, managing and distributing power for the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensor may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface for the processing component 802 and the peripheral interface module, and the peripheral interface module may be a keyboard, a click wheel, a button, etc. The buttons may include but not limited to a home button, a volume button, a start button and a lock button.

The sensor component 814 includes one or more sensors to provide status assessments of various aspects of the device 800. For example, the sensor component 814 may detect the on/off state of the device 800 and the relative positioning of the component. For example, the component is a display and a keypad of the device 800. The sensor component 814 may further detect the position change of the device 800 or a component of the device 800, a presence or absence of contact between the user and the device 800, an orientation or acceleration/deceleration of the device 800, and the temperature change of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 may access wireless networks based on a communication standard, such as WiFi, 2G or 3G; 4G LTE, 5G NR or their combination. In one embodiment, the communication component 816 receives a broadcast signal or broadcast associated information from an external broadcast management system via a broadcast channel. In one embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the device 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronics components, to perform the method as described in the above any embodiment.

In an embodiment, there is also provided a non-transitory computer readable storage medium including instructions, such as a memory 804 including instructions, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

Embodiments of the present disclosure further provide a non-transitory computer-readable storage medium, when the instructions in the storage medium are executed by the processor of the mobile terminal, the mobile terminal can execute the above-mentioned method for live game broadcast interaction.

An application program product/computer program product is also provided according to an embodiment of the present disclosure. In yet another embodiment according to the present disclosure, a computer program product including instructions is also provided. The instructions are run on a computer, and the computer is caused to execute the steps of the method for game live broadcast interaction in any of the above-mentioned embodiments.

In the above-mentioned embodiments, it may be implemented in whole or in part by software, hardware, firmware or their combination. When implemented in software, it can be implemented in whole or in part in the form of a computer program product. The computer program product includes one or more computer program instructions. When the computer program instructions are loaded and executed on a computer, the procedures or functions described in accordance with the embodiments of the present disclosure are produced in whole or in part. The computer may be a general purpose computer, a special purpose computer, computer network, or other programmable device. The computer instructions may be stored in or transmitted from one computer-readable storage medium to another computer-readable storage medium. For example, the computer instructions may be transmitted from a website site, a computer, a server, or a data center to another website site, computer, server or data center by wire (e.g., a coaxial cable, an optical fiber, a digital subscriber line (DSL) or wireless (e.g., infrared, wireless, microwave, etc.). The computer-readable storage medium may be any available medium that is able to be accessed by a computer or may be a data storage device such as a server, a data center and the like that includes an integration of one or more available media. The usable media may be magnetic media (e.g., floppy disks, hard disks, magnetic tapes), optical media (e.g., a digital versatile disc (DVD), or semiconductor media (e.g., a solid state disk (SSD)), etc.

It should be noted that, in this document, relational terms such as first and second are only used to distinguish one entity or operation from another entity or operation, and do not necessarily require or imply any such actual relationship or sequence existed between these entities or operations. Moreover, the terms “comprise”, “include” or any other variation are intended to encompass non-exclusive inclusion such that a process, a method, an article or a device comprising a list of elements includes not only those elements, but also includes other elements not explicitly listed or elements inherent to such process, method, article or device. Without further limitation, an element qualified by a phrase “comprising a . . . ” does not preclude the presence of additional identical elements in a process, method, article or device that includes the element.

After considering the description and practicing the disclosure disclosed herein, those skilled in the art will easily think of other embodiments of the present disclosure. The present disclosure aims to cover any variation, usage or adaptive change of the present disclosure, which follows the general principles of the present disclosure and includes the common knowledge or conventional means in the art not disclosed in the present disclosure. The description and embodiments are only regarded as exemplary, and the true scope and spirit of the present disclosure are pointed out by the following claims.

It should be understood that the disclosure is not limited to the precise structure already described above and shown in the drawings, and various modifications and changes may be made without departing from its scope. The scope of the disclosure is limited only by the appended claims.

What is claimed is:

1. A method for game live broadcast interaction, performed by a terminal, comprising:
in response to detecting that a target account has entered a preset game live broadcast room, obtaining an interaction mode selected by the target account, wherein the interaction mode comprises a shared perspective mode or an independent perspective mode, the shared perspective mode is configured to provide a live broadcast interface from the perspective of an anchor in the preset game live broadcast room, and the independent perspective mode is configured to provide a game interface from the perspective of the target account; and
displaying an interface corresponding to the selected interaction mode on the terminal.

2. The method according to claim 1, further comprising:
in response to detecting that the target account has entered the preset game live broadcast room, obtaining a target selection mode of the target account, wherein the target selection mode comprises an interaction mode or a viewing mode, and wherein in response to the target selection mode being the interaction mode, the interaction mode selected by the target account is obtained.

3. The method according to claim 1, wherein in response to detecting that the target account has entered the preset game live broadcast room, obtaining the interaction mode selected by the target account for the preset game live broadcast room comprises:
in response to detecting that the target account has entered the preset game live broadcast room, entering the shared perspective mode; and
in response to obtaining a mode switching operation of the target account for the preset game live broadcast room, switching the preset game live broadcast room from the shared perspective mode to the independent perspective mode.

4. The method according to claim 1, wherein in the independent perspective mode, the method further comprises:
displaying the game interface of the preset game live room on the terminal, wherein one or more game controls are set on the game interface; and
in response to receiving a trigger operation on the one or more game controls, sending operation data corresponding to the trigger operation to a server.

5. The method according to claim 4, wherein the game controls set on the game interface correspond to different games.

6. The method according to claim 1, further comprising:
in response to successfully joining a game of the anchor, providing the target account with a game picture from the perspective of the target account.

7. The method according to claim 1, wherein the live broadcast interface is also provided with a switching control, and the switching control is configured to switch between an interaction panel and a viewing panel.

8. The method according to claim 7, wherein:
the interaction panel is configured to provide the game interface for the target account; and
the viewing panel is configured to provide the target account with a live game video corresponding to the target account, and the live game video is displayed with at least one of a bullet screen and a reward.

9. The method according to claim 1, further comprising:
in the shared perspective mode, displaying a live game picture of the anchor in a first preset area of the live broadcast interface, and displaying user comments in a second preset area of the live broadcast interface; and
in response to receiving comment information displaying the comment information in the second preset area.

10. The method according to claim 9, further comprising:
in response to receiving a voice connection request of the target account, adding the target account to a connection list, wherein the connection list comprises voice connection requests with different priorities set based on voice connection time; and
in response to detecting that the voice connection request of the target account is of the highest priority, sending a voice connection prompt to the target account.

11. A terminal, further comprising:
a processor; and
a memory for storing instructions executable by the processor;
wherein when the instructions are executed by the processor, the processor is configured to
in response to detecting that a target account has entered a preset game live broadcast room, obtain an interaction mode selected by the target account, wherein the interaction mode comprises a shared perspective mode or an independent perspective mode, the shared perspective mode is configured to provide a live broadcast interface from the perspective of an anchor in the preset game live broadcast room, and the independent perspective mode is configured to provide a game interface from the perspective of the target account; and
display an interface corresponding to the interaction mode on the terminal.

12. The terminal according to claim 11, wherein the processor is further configured to:
in response to detecting that the target account has entered the preset game live broadcast room, obtain a target selection mode of the target account, wherein the target selection mode comprises an interaction mode or a viewing mode and wherein in response to the target selection mode being the interaction mode, the interaction mode selected by the target account is obtained.

13. The terminal according to claim 11, wherein the processor is further configured to:
in response to detecting that the target account has entered the preset game live broadcast room, enter the shared perspective mode; and
in response to obtaining a mode switching operation of the target account for the preset game live broadcast room, switch the preset game live broadcast room from the shared perspective mode to the independent perspective mode.

14. The terminal according to claim 11, wherein in response to the interaction mode being an independent perspective mode, the processor is further configured to:
display the game interface the preset game live room on the terminal, wherein one or more game controls are set on the game interface; and
in response to receiving a trigger operation of the target account on the game controls, send operation data corresponding to the trigger operation to a server.

15. The terminal according to claim 14, wherein the game controls set on the game interface correspond to different games.

16. The terminal according to claim 11, wherein the processor is further configured to:
in response to successfully joining a game of the anchor, provide the target account with a game picture from the perspective of the target account.

17. The terminal according to claim 11, wherein the live broadcast interface is also provided with a switching control, and the switching control is configured to switch between an interaction panel and a viewing panel.

18. The method according to claim 17, wherein:
the interaction panel is configured to provide the game interface for the target account; and
the viewing panel is configured to provide the target account with a live game video corresponding to the target account, and the live game video is displayed with a bullet screen and/or a reward.

19. The terminal according to claim 11, wherein the processor is further configured to:
in the shared perspective mode, display a live game picture of the anchor in a first preset area of the live broadcast interface, and display user comments in a second preset area of the live broadcast interface; and
in response to receiving comment information, display the comment information in the second preset area.

20. The terminal according to claim 19, wherein the processor is further configured to:
in response to receiving a voice connection request of the target account, add the target account to a connection list, wherein the connection list comprises voice connection requests with different priorities set based on voice connection time; and
in response to detecting that the voice connection request of the target account is of the highest priority, send a voice connection prompt to the target account.
